(19) United States
(12) Patent Application Publication
(10) Pub. No.: US 2014/0298638 A1
(43) Pub. Date: Oct. 9, 2014

(54) ELASTIC CLIP RETAINING ARRANGEMENT AND METHOD OF MATING STRUCTURES WITH AN ELASTIC CLIP RETAINING ARRANGEMENT

(71) Applicant: GM GLOBAL TECHNOLOGY OPERATIONS LLC, Detroit, MI (US)

(72) Inventors: Joel Colombo, Howell, MI (US); Steven E. Morris, Fair Haven, MI (US); Jeffrey L. Konchan, Romeo, MI (US)

(73) Assignee: GM GLOBAL TECHNOLOGY OPERATIONS LLC, Detroit, MI (US)

(21) Appl. No.: 13/856,956

(22) Filed: Apr. 4, 2013

(51) Int. Cl. F16B 17/00; B23P 19/04

(52) U.S. Cl. CPC F16B 17/002; B23P 19/04
USPC 29/525.01; 403/280

(57) ABSTRACT

An elastic clip retaining arrangement includes a first structure having a main portion. Also included is a second structure having a plurality of receiving apertures, wherein the second structure is configured to be mated with the first structure. Further included is a plurality of elastically deformable clips extending from the main portion, each of the plurality of elastically deformable clips comprising a neck portion and a head portion, wherein the plurality of elastically deformable clips is configured to elastically deform proximate the neck portion upon contact with the plurality of receiving apertures.

### FIELD OF THE INVENTION

The present invention relates to structure mating arrangements, and more particularly to an elastic clip retaining arrangement, as well as a method of mating structures with the elastic clip retaining arrangement.

### BACKGROUND

Currently, components which are to be mated together in a manufacturing process are subject to positional variation based on the mating arrangements between the components. One common arrangement includes components mutually located with respect to each other by 2-way and/or 4-way male alignment features; typically undersized structures which are received into corresponding oversized female alignment features such as apertures in the form of openings and/or slots. Alternatively, double-sided tape, adhesives or welding processes may be employed to mate parts. Irrespective of the precise mating arrangement, there is a clearance between at least a portion of the alignment features which is predetermined to match anticipated size and positional variation tolerances of the mating features as a result of manufacturing (or fabrication) variances. As a result, occurrence of significant positional variation between the mated components may contribute to the presence of undesirably large and varying gaps and otherwise poor fit. The clearance between the aligning and attaching feature may lead to relative motion between mated components, which contributes to poor perceived quality. Additional undesirable effects include squeaking and rattling of the mated components, for example.

### SUMMARY OF THE INVENTION

In one exemplary embodiment, an elastic clip retaining arrangement includes a first structure having a main portion. Also included is a second structure having a plurality of receiving apertures, wherein the second structure is configured to be mated with the first structure. Further included is a plurality of elastically deformable clips extending from the main portion, each of the plurality of elastically deformable clips comprising a neck portion and a head portion, wherein the plurality of elastically deformable clips is configured to elastically deform proximate the neck portion upon contact with the plurality of receiving apertures.

In another exemplary embodiment, a method of mating structures with an elastic clip retaining arrangement is provided. The method includes inserting a plurality of elastically deformable clips of a first component into a plurality of receiving apertures of a second component, wherein the plurality of elastically deformable clips comprises a neck portion and a head portion. The method also includes contacting the neck portion with the plurality of receiving apertures to impose a contact interference condition between the first component and the second component, wherein upon reaching a fully engaged position of the plurality of elastically deformable clips a fitted alignment between the first component and the second component is established. The method further includes elastically deforming the neck portion upon contacting the plurality of receiving apertures. The method yet further includes performing an elastic averaging of the elastic deformation over the plurality of elastically deformable clips to account for positional variation of the plurality of elastically deformable clips.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective schematic illustration of an elastic clip retaining arrangement;

FIG. 2 is a schematic illustration of the elastic clip retaining arrangement;

FIG. 3 is an enlarged view of a portion of the elastic clip retaining arrangement; and

FIG. 4 is a flow diagram illustrating a method of mating structures with an elastic clip retaining arrangement.

### DESCRIPTION OF THE EMBODIMENTS

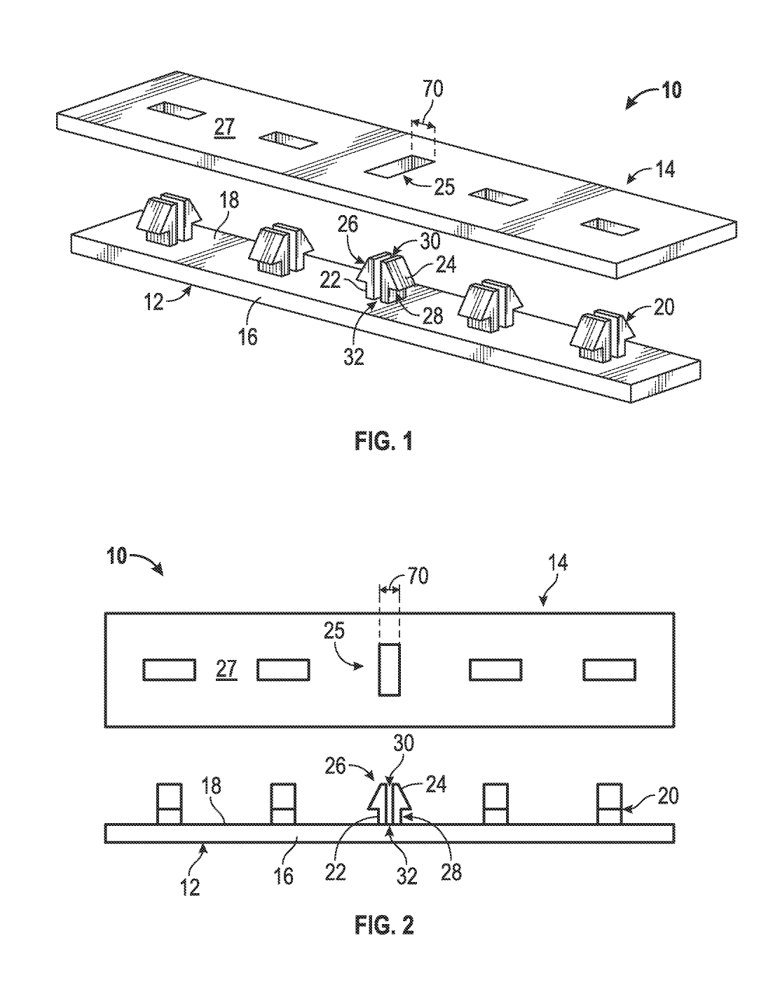

Referring to FIGS. 1 and 2, an elastic clip retaining arrangement 10 is illustrated. The elastic clip retaining arrangement 10 comprises matable components, such as a first component 12 and a second component 14 that are configured to be mated with respect to each other. In one embodiment, the elastic clip retaining arrangement 10 is employed in a vehicle application, and comprises a vehicle feature such as a vehicle body molding assembly. However, it is to be understood that the components may be associated with numerous other applications and industries, such as home appliance and aerospace applications, for example. In an exemplary embodiment such as a vehicle body molding assembly for an automobile, the first component 12 comprises a vehicle body side molding structure and the second component 14 comprises a vehicle sheet metal structure for receiving the vehicle body side molding structure.

Although illustrated in a specific geometry, the first component 12 and the second component 14 may be configured in countless geometries. Irrespective of the precise geometry of the first component 12 and the second component 14, the first component 12 is configured to align with and fittingly mate with the second component 14, which will be described in detail below. In an alternative embodiment, rather than two components comprising the elastic clip retaining arrangement 10, additional layers or components may be included. It is to be appreciated that the elastic clip retaining arrangement 10 is to be employed for providing a self-aligning relationship between components, such as the first component 12 and the second component 14, to each other, while also assisting in securely mating the components to each other.

The first component 12 includes a main portion 16 having a main portion wall 18 that is typically a substantially planar surface. The first component 12 also includes a plurality of elastically deformable clips 20 extending from the main portion 16 in a direction relatively orthogonally from a plane that the main portion wall 18 is disposed in. The plurality of elastically deformable clips 20 are operatively coupled to the main portion 16 and may be integrally formed with the main portion 16. Each of the plurality of elastically deformable clips 20 includes a neck portion 22 and a head portion 24. The second component 14 includes a plurality of receiving apertures 25 defined by a second component wall 27 and configured to engage and receive the plurality of elastically deformable clips 20 upon mating of the first component 12 and the second component 14.

In the exemplary embodiment, the plurality of elastically deformable clips 20 includes a first clip portion 26 and a second clip portion 28, which are disposed in close proximity, yet spaced from one another, thereby forming a recess 30 therebetween. As shown, at least one of the plurality of elastically deformable clips 20 is disposed in a first orientation, while the remaining clips are disposed in a second orientation. More particularly, at least one of the plurality of elastically deformable clips 20 is oriented substantially orthogonally, relative to the remaining clips. In the illustrated example, a centrally disposed clip 32 is oriented in the above-noted first direction and located centrally, with respect to the remaining clips. As will be apparent from the description below, the centrally disposed clip 32 provides positional location of the first component 12 relative to the second component 14 in a first direction, such as fore-aft, for example, while the remaining clips provide positional location of the first component 12 relative to the second component 14 in a second direction, such as vertically, as viewed in FIG. 1, for example. As will be apparent from the description herein, the elastically deformable nature of the clips, in combination with the particular orientations described above, facilitates precise alignment of the first component 12 relative to the second component 14 by accounting for positional variation of the retaining and/or locating features of the first component 12 and the second component 14 inherently present due to manufacturing processes. The self-aligning benefits associated with the elastic clip retaining arrangement 10 will be described in detail below. Additionally, the tendency of the ends of the first component 12 to pull away from the second component 14 is reduced by the “floating” aspect provided by the plurality of elastically deformable clips 20.

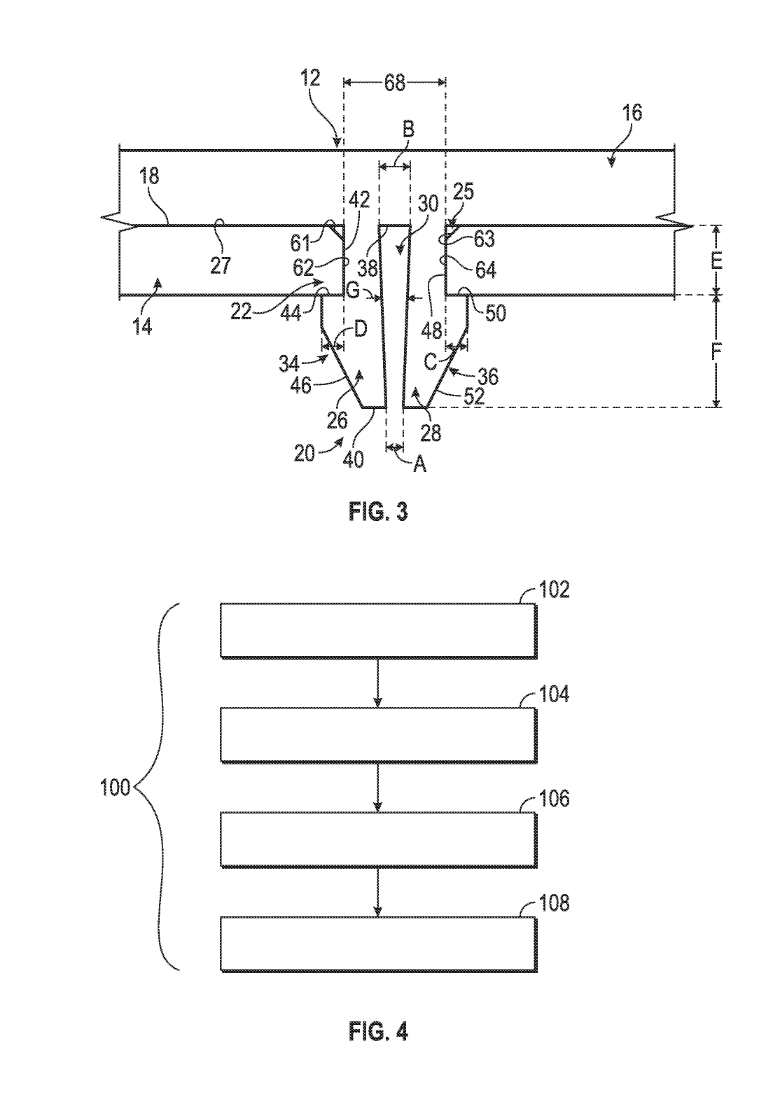

Referring to FIG. 3, illustrated is an enlarged cross-sectional view of one of the plurality of elastically deformable clips 20 of the first component 12 that is engaged with one of the plurality of receiving apertures 25 of the second component 14. As noted above, the clip includes a first clip portion 26 and a second clip portion 28. Although the plurality of elastically deformable clips 20 is illustrated and described herein as a two-portion, separated component, it is to be appreciated that the clips may be a single clip feature comprising numerous geometries, including circular for example. Similarly, it is contemplated that the plurality of receiving apertures 25 may be formed of alternative geometries, such as circular to correspond to the geometry of the clips.

In the illustrated embodiment, the plurality of elastically deformable clips 20 includes a first wall 34 and a second wall 36 extending from a first end 38 proximate the main portion wall 18 to a second end 40 located distally from the first end 38. In an exemplary embodiment, the first wall 34 comprises a first neck portion wall 42 extending from the first end 38 to an intermediate shoulder 44 in an orientation relatively perpendicular to the main portion wall 18. The intermediate shoulder 44 extends outwardly away from the first neck portion wall 42. The first wall 34 also includes a first head portion wall 46 extending from the intermediate shoulder 44 to the second end 40 of the first wall 34. The first head portion wall 46 is disposed at an angle to the first neck portion wall 42, and more specifically at an angle that tapers inwardly toward the second wall 36. The second wall 36 comprises a second neck portion wall 48 extending from the first end 38 to an intermediate shoulder 50 of the second wall 36 in an orientation relatively perpendicular to the main portion wall 18. The intermediate shoulder 50 extends outwardly away from the second neck portion wall 48. The second wall 36 also includes a second head portion wall 52 extending from the intermediate shoulder 50 of the second wall 36 to the second end 40 of the second wall 36. The second head portion wall 52 is disposed at an angle to the second neck portion wall 48, and more specifically at an angle that tapers inwardly toward the first wall 34. Extending through the clip is the recess 30 extending from the second end 40 of the clip between the first wall 34 and the second wall 36 and toward the first end 38 of the clip.

As described above, the plurality of receiving apertures 25 may be formed in the second component wall 27 in a variety of geometrical cutout formations. In the illustrated embodiment, a rectangular aperture is shown to correspond to the neck portion 22 of the plurality of elastically deformable clips 20. The plurality of receiving apertures 25 includes a first engagement surface 62 and a second engagement surface 64. The first engagement surface 62 and the second engagement surface 64 respectively include a first chamfer portion 61 and a second chamfer portion 63, which are each disposed proximate the second component wall 27. The first chamfer portion 61 and the second chamfer portion 63 comprise beveled surfaces and are configured to provide a “lead-in” region for the first wall 34 and the second wall 36 of the plurality of elastically deformable clips 20. Numerous angles of the first chamfer portion 61 and the second chamfer portion 63 are contemplated.

The plurality of elastically deformable clips 20 of the first component 12 are positioned and engaged with the plurality of receiving apertures 25 of the second component 14 upon translation of the first component 12 toward the second component 14. The first head portion wall 46 and the second head portion wall 52 engage the first engagement surface 62 and the second engagement surface 64, respectively, and more specifically the first chamfer portion 61 and the second chamfer portion 63, respectively. Subsequent translation of the first portion 26 and the second portion 28 of the clips results in an elastic deformation of the first portion 26 and the second portion 28. Depending on the positional variance of the features of the first component 12 and the second component 14, elastic deformation of one or both of the first portion 26 and the second portion 28 may occur in response to resistance imposed on the first wall 34 and the second wall 36 by the engagement surfaces of the plurality of receiving apertures 25. It is to be appreciated that elastic deformation of the first portion 26 and the second portion 28 is further facilitated by the presence of the recess 30 disposed between the first portion 26 and the second portion 28. The void of material proximate the recess 30 enhances the flexibility of the plurality of elastically deformable clips 20 in regions closely located to the recess 30.

Any suitable elastically deformable material may be used for the plurality of elastically deformable clips 20. More specifically, elastically deformable material is disposed proximate, or integral to, the first portion 26 and the second portion 28. The term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Numerous examples of materials that may at least partially form the components include various metals, polymers, ceramics, inorganic materials or glasses, or composites of any of the aforementioned materials, or any other combinations thereof Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS), such as an ABS acrylic. The material may be in any form and formed or manufactured by any suitable process, including stamped or formed metal, composite or other sheets, forgings, extruded parts, pressed parts, castings, or molded parts and the like, to include the deformable features described herein. The material, or materials, may be selected to provide a predetermined elastic response characteristic of the plurality of elastically deformable clips 20. The predetermined elastic response characteristic may include, for example, a predetermined elastic modulus.

The precise position where engagement between the first wall 34 and the second wall 36 and the plurality of receiving apertures 25 occurs will vary depending on positional variance imposed by manufacturing factors. Due to the elastically deformable properties of the elastic material comprising the plurality of elastically deformable clips 20, the criticality of the initial location of engagement is reduced. Further insertion of the plurality of elastically deformable clips 20 into the plurality of receiving apertures 25 ultimately leads to a fully engaged position of the plurality of elastically deformable clips 20. As the clip is inserted into the receiving aperture, engagement of the first head portion wall 46 and the second head portion wall 52 results in the first portion 26 and the second portion 28 being elastically deformed and cantilevered inwardly toward each other, thereby decreasing the volume of the recess 30. The illustrated fully engaged position comprises engagement of the first engagement surface 62 with the first neck portion wall 42, as well as engagement of the second engagement surface 64 with the second neck portion wall 48. Additionally, in the fully engaged position, the intermediate shoulders 44, 50 are engaged with the second component 14.

In the fully engaged position, a tight, fitted engagement between the plurality of elastically deformable clips 20 and the plurality of receiving apertures 25 is achieved by the contact interfaces located between the first wall 34, the second wall 36 and the engagement surfaces 62, 64, respectively. Such a condition is ensured by sizing a neck portion width 68 (FIG. 3) to be larger than a receiving aperture width 70 (FIG. 2). The neck portion width 68 is defined by the distance between the first neck portion wall 42 and the second neck portion wall 48. The receiving aperture width 70 is defined by the distance between the first engagement surface 62 and the second engagement surface 64. The interference between the plurality of elastically deformable clips 20 and the plurality of receiving apertures 25 causes elastic deformation proximate the neck portions. The malleability of the materials reduces issues associated with positional variance. More particularly, in contrast to a rigid insert that typically results in gaps between the insert and receiving structure at portions around the perimeter of the insert, the plurality of elastically deformable clips 20 advantageously deforms to maintain alignment of the first component 12 and the second component 14, while also reducing or eliminating gaps associated with manufacturing challenges.

In the illustrated embodiment, certain dimensions are labeled to describe advantageous dimensional relationships of the elastic clip retaining arrangement 10. For the first component 12 and the second component 14 to be removable from each other, an opening width A is greater than the sum of length C and length D times the ratio of the overall feature length E added to F, the sum of which is divided by length F. The preceding dimensional relationship may be expressed by the following:

$$A \geq ( C + D ) * \frac{E + F}{F}$$

Referring again to FIGS. 1 and 2, the elastic deformation of the plurality of elastically deformable clips 20 elastically averages any positional errors between the first component 12 and the second component 14. In other words, gaps that would otherwise be present due to positional errors associated with portions or segments of the first component 12 and the second component 14, particularly locating and retaining features, are eliminated by offsetting the gaps with an over-constrained condition of other elastically deformable clips. Specifically, the positional variance of each clip is offset by the remaining clips to average, in aggregate, the positional variance of each other clip.

Elastic averaging provides elastic deformation of the interface(s) between mated components, wherein the average deformation provides a precise alignment, the manufacturing positional variance being minimized to Xₘᵢₙ, defined by Xₘᵢₙ=X√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, the disclosure of which is incorporated by reference herein in its entirety. The embodiments disclosed above provide the ability to convert an existing component that is not compatible with the above-described elastic averaging principles to an assembly that does facilitate elastic averaging and the benefits associated therewith.

A method of mating structures with an elastic clip retaining arrangement 100 is also provided, as illustrated in FIG. 4, and with reference to FIGS. 1-3. The elastic clip retaining arrangement 10, and more specifically the elastically deformable nature of the plurality of elastically deformable clips 20 have been previously described and specific structural components need not be described in further detail. The method 100 includes inserting 102 the plurality of elastically deformable clips 20 of the first component 12 into the plurality of receiving apertures 25 of the second component 14. The method also includes contacting 104 the neck portion 22 with the plurality of receiving apertures 25 to impose a contact interference condition between the first component 12 and the second component 14, wherein upon reaching a fully engaged position of the plurality of elastically deformable clips 20, a fitted alignment between the first component 12 and the second component 14 is established. The method further includes elastically deforming 106 the neck portion 22 upon contacting 104 the plurality of receiving apertures 25. The method yet further includes performing 108 an elastic averaging of the elastic deformation over the plurality of elastically deformable clips 20 to account for positional variation of the plurality of elastically deformable clips 20.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastic clip retaining arrangement comprising:
a first structure having a main portion;
a second structure having a plurality of receiving apertures, wherein the second structure is configured to be mated with the first structure; and
a plurality of elastically deformable clips extending from the main portion, each of the plurality of elastically deformable clips comprising a neck portion and a head portion, wherein the plurality of elastically deformable clips is configured to elastically deform proximate the neck portion upon contact with the plurality of receiving apertures.

2. The elastic clip retaining arrangement of claim 1, further comprising a fully engaged position of the first structure, wherein the fully engaged position comprises contact interference between the plurality of elastically deformable clips with the plurality of receiving apertures, wherein an amount of deformation of the plurality of elastically deformable clips is averaged in aggregate relative to each other.

3. The elastic clip retaining arrangement of claim 1, wherein the plurality of elastically deformable clips is operatively coupled to the main portion.

4. The elastic clip retaining arrangement of claim 1, wherein the plurality of elastically deformable clips is integrally formed with the main portion.

5. The elastic clip retaining arrangement of claim 1, wherein at least one of the plurality of elastically deformable clips is oriented substantially orthogonal relative to the remaining plurality of elastically deformable clips.

6. The elastic clip retaining arrangement of claim 5, wherein the at least one clip is centrally disposed along the main portion relative to the remaining plurality of elastically deformable clips.

7. The elastic clip retaining arrangement of claim 1, wherein the plurality of elastically deformable clips comprises a first clip portion and a second clip portion.

8. The elastic clip retaining arrangement of claim 7, wherein the first clip portion comprises a first wall having a first head portion wall and a first neck portion wall, and wherein the second clip portion comprises a second wall having a second head portion wall and a second neck portion wall.

9. The elastic clip retaining arrangement of claim 8, wherein the plurality of receiving apertures comprises a first engagement surface and a second engagement surface, the first clip portion configured to elastically deform at a first interface and a second interface upon contact with the plurality of receiving apertures, wherein the first interface is located proximate the first wall and the first engagement surface, and wherein the second interface is located proximate the second wall and the second engagement surface.

10. The elastic clip retaining arrangement of claim 7, further comprising a recess disposed between the first clip portion and the second clip portion.

11. The elastic clip retaining arrangement of claim 8, wherein the plurality of receiving apertures includes a first chamfer portion configured to contact the first head portion wall and a second chamfer portion configured to contact the second head portion wall, wherein the first head portion wall and the second head portion wall include a tapered surface corresponding to the first chamfer portion and the second chamfer portion.

12. The elastic clip retaining arrangement of claim 1, further comprising a neck portion width and a receiving aperture width, wherein the neck portion width is greater than the receiving aperture width.

13. The elastic clip retaining arrangement of claim 12, wherein the neck portion width is defined by a distance between a first neck portion wall and a second neck portion wall, and wherein the receiving aperture width is defined by a distance between a first engagement surface and a second engagement surface of the plurality of receiving apertures.

14. The elastic clip retaining arrangement of claim 1, wherein the elastic clip retaining arrangement comprises vehicle components.

15. The elastic clip retaining arrangement of claim 14, wherein the first component comprises a vehicle body side molding structure, and wherein the second component comprises a vehicle sheet metal structure.

16. A method of mating structures with an elastic clip retaining arrangement comprising:
inserting a plurality of elastically deformable clips of a first component into a plurality of receiving apertures of a second component, wherein the plurality of elastically deformable clips comprises a neck portion and a head portion;
contacting the neck portion with the plurality of receiving apertures to impose a contact interference condition between the first component and the second component, wherein upon reaching a fully engaged position of the plurality of elastically deformable clips a fitted alignment between the first component and the second component is established;
elastically deforming the neck portion upon contacting the plurality of receiving apertures; and
performing an elastic averaging of the elastic deformation over the plurality of elastically deformable clips to account for positional variation of the plurality of elastically deformable clips.

17. The method of claim 16, wherein elastically deforming the neck portion comprises compressing a first clip portion and a second clip portion toward a recess disposed therebetween.

18. The method of claim 17, wherein inserting the plurality of elastically deformable clip portions into the plurality of receiving apertures comprises contacting inwardly tapered portions of the first clip portion and the second clip portion with the plurality of receiving apertures, wherein the inwardly tapered portions facilitate entry to the plurality of receiving apertures.

19. The method of claim 16, wherein inserting the plurality of elastically deformable clips into the plurality of receiving apertures comprises inserting at least one of the plurality of elastically deformable clips at an orientation substantially orthogonal to the remaining plurality of elastically deformable clips.

20. The method of claim 19, wherein mating the structures comprises mating a vehicle body side molding structure to a vehicle sheet metal structure.
